(19) United States
(12) Patent Application Publication
(10) Pub. No.: US 2026/0193380 A1
(43) Pub. Date: Jul. 9, 2026

(54) METHOD FOR PREPARING V-TYPE PREGELATINIZED HYDROXYPROPYL STARCH WITH HIGH DEGREE OF SUBSTITUTION

(71) Applicant: Jiangnan University, Wuxi (CN)

(72) Inventors: Xing ZHOU, Wuxi (CN); Zhenye SUN, Wuxi (CN); Ren WANG, Wuxi (CN); Zhengyu JIN, Wuxi (CN)

(21) Appl. No.: 19/444,141

(22) Filed: Jan. 8, 2026

(30) Foreign Application Priority Data
Jan. 9, 2025 (CN) 202510032543.X

(51) Int. Cl. C08B 31/12; A23L 29/219

(52) U.S. Cl. CPC C08B 31/12; A23L 29/219

(57) ABSTRACT

A method for preparing V-type pregelatinized hydroxypropyl starch including the following steps: extruding a mixture of starch and an ethanol aqueous solution—with the ethanol concentration of the solution ranging from 30% to 50% by volume and the mass ratio of starch to the ethanol aqueous solution being 1:0.4 to 1:1—to form an extrudate, followed by drying and pulverizing the extrudate to obtain extrusion-modified starch A; then contacting extrusion-modified starch A with an ethanol solution, adjusting the pH of the mixture to an alkaline range, reacting the mixture with propylene oxide under specified reaction conditions to form a reaction system, adjusting the pH of the reaction system to an acidic range to terminate the reaction, separating the solid product from the system via suction filtration, washing the solid product, and drying it to obtain the target V-type pregelatinized hydroxypropyl starch.

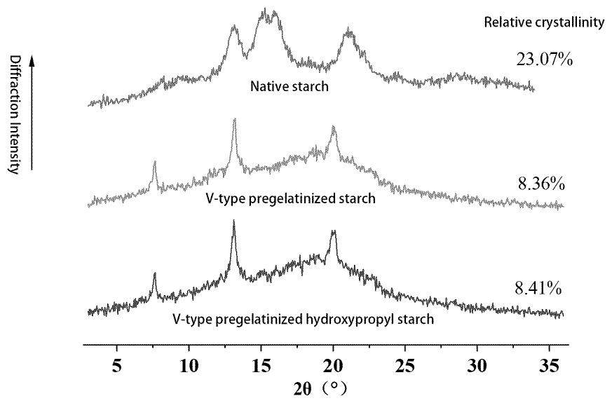

### CROSS-REFERENCE TO RELATED APPLICATIONS

Pursuant to 35 U.S.C. § 119 and the Paris Convention Treaty, this application claims foreign priority to Chinese Patent Application No. CN202510032543.X filed Jan. 9, 2025, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of starch modification, and more particularly to a method for preparing a V-type pregelatinized hydroxypropyl starch with a high degree of substitution.

Hydroxypropyl starch is a starch substituted ether obtained by introducing hydroxypropyl groups through the reaction of propylene oxide with the hydroxyl groups of starch molecules under alkaline conditions. Because the hydroxypropyl groups exhibit strong hydrophilicity, they can weaken the intramolecular hydrogen bonds within the starch and enhance the hydrogen bonding between starch molecules and water molecules. As a result, this modification process significantly improves the clarity, stability, and retrogradation resistance of starch paste.

Pregelatinized hydroxypropyl starch is a functional starch obtained through dual modification involving both pregelatinization and hydroxypropylation. The starch exhibits excellent solubility in water, with a dissolution rate in cold water significantly higher than that of ordinary starch, thereby facilitating ease of processing and use. The pregelatinization process enables the starch to retain a partially gelatinized structure after drying, while the hydroxypropylation further enhances its thermal stability and retrogradation resistance. Thereby, this class of starch demonstrates strong overall stability and reduced retrogradation phenomena.

In conventional methods, pregelatinized hydroxypropyl starch is typically prepared by conducting hydroxypropylation first, followed by pregelatinization using drum drying method. However, the compact structure of ungelatinized starch granules leads to low efficiency in the hydroxypropylation reaction, often resulting in incomplete reactions or side reactions, thereby compromising the quality of the final product. In addition, if pregelatinization is performed subsequent to hydroxypropylation, the high-temperature and shear conditions during pregelatinization cause damage to the starch granules and the cleavage of hydroxypropyl-substituted molecules, leading to reduced viscosity. Consequently, the aforementioned traditional preparation method for hydroxypropyl pregelatinized starch exhibits limitations. In contrast, the process of pregelatinization followed by hydroxypropylation may circumvent the issues associated with the traditional method. Nevertheless, pregelatinized starch dramatically increases system viscosity, making the reaction mixture very thick and difficult to mix uniformly. This poses significant challenges for achieving a consistent and even hydroxypropylation reaction. Reducing concentration to manage viscosity leads to low reaction efficiency and is impractical for production.

The issue of low degree of substitution is typically addressed by optimizing the amount of propylene oxide used, increasing the reaction pH, and raising the reaction temperature. Among these, increasing the dosage of propylene oxide is the most effective, as the method elevates the concentration of epoxy groups relative to the starch, thereby increasing the probability of reaction with the swollen starch radicals and enhancing the degree of etherification. However, according to the requirements of the Chinese National Standard GB 29930-2013, the mass fraction of hydroxypropyl groups in food additive hydroxypropyl starch must not exceed 7%. Consequently, in the field of food additives, the amount of propylene oxide added should preferably not exceed 7%, which limits the improvement in the degree of substitution for preparing pregelatinized hydroxypropyl starch.

Recent research has found that ethanolic extrusion modified V-type starch exhibits stronger reactivity compared to native starch. This is because the V-type single-helix structure leads to the exposure of hydrophobic hydroxyl groups, providing more reactive sites for propylene oxide during the reaction. Therefore, utilizing ethanolic extrusion modified V-type starch for the preparation of pregelatinized hydroxypropyl starch holds promise for achieving higher reaction efficiency, thereby increasing its degree of substitution.

While ethanolic extrusion has been employed to produce V-type starch, its subsequent application in hydroxypropylation processes remains unaddressed in the prior art. Moreover, it has been found that not all ethanolic extrusion modified V-type starches are effective in significantly enhancing the degree of substitution of the resulting pregelatinized hydroxypropyl starch. Consequently, identifying the specific conditions under which ethanolic extrusion modified V-type starch can successfully yield a product with a high degree of substitution represents a critical and unresolved technical challenge.

### SUMMARY

One object of the disclosure is to provide an efficient method for preparing pregelatinized hydroxypropyl starch. This method involves first preparing V-type pregelatinized starch via ethanolic extrusion, followed by hydroxypropylation treatment. Unlike the conventional process which performs hydroxypropylation first followed by gelatinization, the V-type pregelatinized hydroxypropyl starch produced by the inventive process exhibits superior dispersibility in cold water and a lower agglomeration rate. These properties are particularly advantageous for the development of instant powder formulations. Furthermore, the resulting pregelatinized starch product demonstrates enhanced overall quality. The extrusion-based method also allows for higher production throughput and lower cost, indicating significant commercial potential.

Specifically, the disclosure provides a method for preparing pregelatinized hydroxypropyl starch, comprising:
(1) extruding a mixture of a starch and an ethanol aqueous solution to form an extrudate, drying and pulverizing the extrudate to obtain an extrusion-modified starch A, wherein the ethanol aqueous solution has an ethanol concentration of 30% to 50% by volume, and a mass ratio of the starch to the ethanol aqueous solution is from 1:0.4 to 1:1; and
(2) contacting the extrusion-modified starch A with an ethanol solution, adjusting a pH of a resulting mixture to an alkaline range, contacting the resulting mixture with propylene oxide under reaction conditions to form a reaction mixture, adjusting a pH of the reaction mixture to an acidic range to terminate the reaction, separating a solid product from the reaction mixture by suction filtration, washing the solid product, and drying the solid product, thereby obtaining the V-type pregelatinized hydroxypropyl starch.

In a class of this embedment, the starch comprises one or more selected from the group consisting of ordinary corn starch, rice starch, potato starch, wheat starch, barley starch, and tapioca starch.

In a class of this embedment, the extruding in (1) is performed using an extruder; and parameters of the extruder are set to: a heating temperature in a premixing zone of 50° C. to 60° C., a temperature in a gelatinization zone of 70° C. to 100° C., a temperature in a forming zone of 40° C. to 50° C., and an extruder screw speed of 80 to 200 rpm.

In a class of this embodiment, in (1), pulverizing the extrudate is carried out using a continuous cyclone pulverizer having a screen mesh size of from 0.8 to 1.5 mm.

In a class of this embedment, the ethanol solution in (2) has an ethanol concentration of 80% to 100% by volume.

In a class of this embedment, in (2), a mass ratio of the extrusion-modified starch A to the ethanol solution is from 1:3 to 1:4.

In a class of this embedment, in (2), the alkaline range is from 10.5 to 12.0, and particularly from 11.0 to 11.5.

In a class of this embedment, in (2), an amount of the propylene oxide added is 5% to 7% by mass of the starch, particularly 7%; and the reaction is performed by maintaining a temperature of 60° C. to 80° C. for 4 to 10 hours after adding the propylene oxide.

In a class of this embedment, in (2), the acidic range is from 4.0 to 6.0.

In a class of this embedment, washing the solid product is performed using absolute ethanol or an ethanol aqueous solution.

In a class of this embedment, the drying in (2) is carried out at a temperature ranging from 40° C. to 60° C.

The disclosure also provides a V-type pregelatinized hydroxypropyl starch prepared according to the method.

The disclosure further provides a method comprising incorporating the V-type pregelatinized hydroxypropyl starch into a food product.

In a class of this embedment, the food product is selected from the group consisting of an instant powder formulation, a seasoning sauce, a soluble capsule, and an edible film.

The following advantages are associated with the method for preparing a V-type pregelatinized hydroxypropyl starch with a high degree of substitution of the disclosure.
1) Excellent product performance: The method of the disclosure employs an ethanolic extrusion treatment first to obtain a V-type pregelatinized starch with high reactivity and a V-type single-helix crystalline structure. This V-type pregelatinized starch enables an increased degree of substitution in the subsequent hydroxypropylation, allowing the resulting hydroxypropyl starch to achieve a degree of substitution above 0.9, while also exhibiting favorable water separation rate and a low agglomeration rate.
2) Efficient and simple preparation: The preparation process of the disclosure is straightforward, involves few steps, offers high yield, and is suitable for industrial-scale application. Furthermore, a hydroxypropyl starch with a high degree of substitution is obtained under the condition that the addition amount of propylene oxide does not exceed 7%, complying with relevant standards.

### BRIEF DESCRIPTION OF THE DRAWINGS

The invention is described hereinbelow with reference to accompanying drawings, in which the sole FIGURE shows the X-ray diffraction patterns and the corresponding relative crystallinity for the V-type pregelatinized starch, the V-type pregelatinized hydroxypropyl starch prepared in Example 1 of the disclosure, and the native starch.

### DETAILED DESCRIPTION

To further illustrate the disclosure, embodiments detailing a method for preparing a V-type pregelatinized hydroxypropyl starch with a high degree of substitution are described below. It should be noted that the following embodiments are intended to describe and not to limit the disclosure.

### 1. Test Method for Freeze-Thaw Stability

A predetermined amount of a sample is placed into a pre-weighed centrifuge tube (M₀) and formulated into a 3% starch paste (calculated on a dry basis). The total weight is recorded as M₁, and the paste is cooled to room temperature. The sample is then placed in a freezer at −18° C. for 24 h, removed, and allowed to thaw naturally at room temperature for 2 h. Thereafter, the sample is centrifuged at 3,000 r/min for 20 min. The supernatant is removed, and the weight of the remaining residue is recorded as M₂. The water separation rate is calculated according to the following formula: Water separation rate (%)=((M₁−M₂)/(M₁−M₀))×100%.

The freeze-thaw cycle is repeated five times, and the water separation rate obtained from the fifth cycle is taken as the final data.

### 2. Test Method for Crystallinity

The crystalline structure of a sample is analyzed using an X-ray diffractometer, with a scanning angle range of 3-36° (2θ) and a scanning speed of 0.05°/s. The relative crystallinity is calculated using MDI JADE software as a ratio of the area of the characteristic crystalline peaks to the total diffraction area. Specifically, the area of the V-type characteristic peaks (7.8°, 13.5°, and 20.8°) or the area of the A-type characteristic peaks (15°, 17°, 18°, and 23°) is divided by the total area of all diffraction peaks within the scanning range. The calculation formula is as follows: Relative crystallinity (%)=CDA/TDA×100;
where CDA represents a peak area of the characteristic crystalline peaks, and TDA represents a total area of all diffraction peaks within the scanning range.

### 3. Test Method for Degree of Substitution

A hydroxypropyl starch sample of 0.04-0.06 g is accurately weighed and transferred into a 100 mL volumetric flask. Using a pipette, 25 mL of 0.5 M sulfuric acid solution is added to the flask. The mixture is heated in a boiling water bath to fully gelatinize the starch. After heating for 30 min, the starch paste solution in the flask is cooled to room temperature.

A 25 mL glass-stoppered test tube is prepared in advance and immersed in an ice-water bath. 1 mL of the above starch paste solution is pipetted into the test tube, followed by slow addition of 8 mL of concentrated sulfuric acid. The test tube is inverted several times to mix thoroughly. The tube is then heated in a boiling water bath for 30 min for decomposition. Upon completion of the reaction, the test tube is immediately transferred to the ice-water bath.

After the sample has cooled to room temperature, 0.6 mL of a 3% ninhydrin indicator solution is slowly added. The tube is again inverted to mix and then placed in a 25° C. water bath for 100 min. Subsequently, concentrated sulfuric acid is added to bring the total volume of the liquid in the tube to 25 mL, and the tube is inverted to ensure uniform mixing.

Using distilled water as a reference, the solution is transferred to a cuvette and allowed to stand for 5 min. The absorbance is measured at 595 nm using an ultraviolet spectrophotometer. The molar substitution (MS) of hydroxypropyl groups in the sample is calculated based on the propylene glycol content derived from the absorbance.

The mass fraction of hydroxypropyl groups, H (%), and the molar substitution degree, MS, are calculated according to the following formulas:

$$H ( \% ) = F \times ( {M}_{1} / {W}_{1} - {M}_{0} / {W}_{0} ) \times 0.7763 \times 100$$

$$MS = 2.79 \times H / ( 100 - H )$$

wherein:
H is the hydroxypropyl content in percent (%);
F is the dilution factor for the sample or blank;
M₁ is the mass of propylene glycol in the sample obtained from the standard calibration curve (g);
M₀ is the mass of propylene glycol in the native starch blank obtained from the standard calibration curve (g);
W₁ is the mass of the sample (g);
W₀ is the mass of the native starch (g);
0.7763 is the conversion factor from propylene glycol content to hydroxypropyl content; and
2.79 is the conversion factor from hydroxypropyl percentage content to the molar substitution degree.

### 4. Test Method for Agglomeration Rate

100 mL of deionized water is measured and heated to boiling on an electric hot plate. 5 g of a sample is placed into a beaker, and 30 mL of deionized water cooled to 80° C. is added. The mixture is stirred thoroughly with a glass rod for 5 min and then allowed to stand for 1 min to observe any stratification.

A 20-mesh sieve (whose weight has been recorded in advance) is used to filter the sample solution. The agglomerates are rinsed gently with clean water, placed in a 105° C. oven, and dried to constant weight. The sieve is weighed again, and the dry weight of the agglomerates is obtained by subtracting the weight of the sieve.

The agglomeration rate is calculated according to formula (2-1):

$$Agglomeration rate ( \% ) = ( m / ( M \times ( 1 - a ) ) ) \times 100$$

where, m is a dry weight of the agglomerates (g), Mis a mass of the sample (g), and a is a moisture content of the sample (%).

### Example 1

Tapioca starch was selected as the raw material. The solid feed rate of the extruder was set at 600 g/h. An ethanol aqueous solution with an ethanol concentration of 40% by volume was prepared, and the liquid feed rate was adjusted so that the mass ratio of starch to the ethanol aqueous solution was 1:0.56.

The extruder operating parameters were as follows: the heating temperature in the premixing zone was 60° C., the temperature in the gelatinization zone was 95° C., the temperature in the forming zone was 50° C., and the extruder screw speed was 100 rpm.

The extrudate was cut into segments of approximately 0.5 cm and then dried in an oven at 40° C. for 20 hours. Subsequently, the dried material was pulverized using a continuous cyclone pulverizer equipped with a screen mesh size of 1.0 mm, yielding V-type pregelatinized starch A.

Next, 10 g of the obtained V-type pregelatinized starch A was weighed and placed into a 50 mL centrifuge tube. Then, 30 mL of an ethanol aqueous solution with a concentration of 85% by volume was added. The pH of the mixture was adjusted to 11.0 using a 10% sodium hydroxide (NaOH) solution, followed by the addition of 0.7 g of propylene oxide.

The reaction was carried out in a water bath at 75° C. for 6 hours. Upon completion, the reaction was terminated by adjusting the pH of the system to 5.0 using a 10% hydrochloric acid (HCl) solution. The product was then isolated by suction filtration, washed, dried, and pulverized to obtain a pregelatinized hydroxypropyl starch.

### Example 2

Potato starch was selected as the raw material. The solid feed rate of the extruder was set at 600 g/h. An ethanol aqueous solution with an ethanol concentration of 35% by volume was prepared, and the liquid feed rate was adjusted so that the mass ratio of starch to the ethanol aqueous solution was 1:0.48.

The extruder operating parameters were as follows: the heating temperature in the premixing zone was 60° C., the temperature in the gelatinization zone was 100° C., the temperature in the forming zone was 50° C., and the extruder screw speed was 100 rpm.

The extrudate was cut into segments of approximately 0.5 cm and then dried in an oven at 40° C. for 24 hours. Subsequently, the dried material was pulverized using a continuous cyclone pulverizer equipped with a screen mesh size of 1.0 mm, yielding V-type pregelatinized starch A.

Next, 10 g of the obtained V-type pregelatinized starch A was weighed and placed into a 50 mL centrifuge tube. Then, 30 mL of an ethanol aqueous solution with a concentration of 90% by volume was added. The pH of the mixture was adjusted to 11.6 using a 10% sodium hydroxide (NaOH) solution, followed by the addition of 0.7 g of propylene oxide.

The reaction was carried out in a water bath at 80° C. for 8 hours. Upon completion, the reaction was terminated by adjusting the pH of the system to 5.0 using a 10% hydrochloric acid (HCl) solution. The product was then isolated by suction filtration, washed, dried, and pulverized to obtain a hydroxypropyl starch.

### Example 3

Barley starch was selected as the raw material. The solid feed rate of the extruder was set at 600 g/h. An ethanol aqueous solution with an ethanol concentration of 40% by volume was prepared, and the liquid feed rate was adjusted so that the mass ratio of starch to the ethanol aqueous solution was 1:0.56.

The extruder operating parameters were as follows: the heating temperature in the premixing zone was 60° C., the temperature in the gelatinization zone was 95° C., the temperature in the forming zone was 50° C., and the extruder screw speed was 140 rpm.

The extrudate was cut into segments of approximately 0.5 cm and then dried in an oven at 40° C. for 20 hours. Subsequently, the dried material was pulverized using a continuous cyclone pulverizer equipped with a screen mesh size of 1.0 mm, yielding V-type pregelatinized starch A.

Next, 10 g of the obtained V-type pregelatinized starch A was weighed and placed into a 50 mL centrifuge tube. Then, 30 mL of an ethanol aqueous solution with a concentration of 95% by volume was added. The pH of the mixture was adjusted to 11.7 using a 10% sodium hydroxide (NaOH) solution, followed by the addition of 0.7 g of propylene oxide.

The reaction was carried out in a water bath at 65° C. for 6 hours. Upon completion, the reaction was terminated by adjusting the pH of the system to 5.0 using a 10% hydrochloric acid (HCl) solution. The product was then isolated by suction filtration, washed, dried, and pulverized to obtain a hydroxypropyl starch.

### Example 4

Ordinary corn starch was selected as the raw material. The solid feed rate of the extruder was set at 600 g/h. An ethanol aqueous solution with an ethanol concentration of 40% by volume was prepared, and the liquid feed rate was adjusted so that the mass ratio of starch to the ethanol aqueous solution was 1:0.4.

The extruder operating parameters were as follows: the heating temperature in the premixing zone was 60° C., the temperature in the gelatinization zone was 90° C., the temperature in the forming zone was 50° C., and the extruder screw speed was 120 rpm.

The extrudate was cut into segments of approximately 0.5 cm and then dried in an oven at 40° C. for 20 hours. Subsequently, the dried material was pulverized using a continuous cyclone pulverizer equipped with a screen mesh size of 1.0 mm, yielding V-type pregelatinized starch A.

Next, 10 g of the obtained V-type pregelatinized starch A was weighed and placed into a 50 mL centrifuge tube. Then, 30 mL of absolute ethanol was added. The pH of the mixture was adjusted to 11.3 using a 10% sodium hydroxide (NaOH) solution, followed by the addition of 0.7 g of propylene oxide.

The reaction was carried out in a water bath at 60° C. for 4 hours. Upon completion, the reaction was terminated by adjusting the pH of the system to 5.0 using a 10% hydrochloric acid (HCl) solution. The product was then isolated by suction filtration, washed, dried, and pulverized to obtain a hydroxypropyl starch.

### Example 5

Wheat starch was selected as the raw material. The solid feed rate of the extruder was set at 600 g/h. An ethanol aqueous solution with an ethanol concentration of 40% by volume was prepared, and the liquid feed rate was adjusted so that the mass ratio of starch to the ethanol aqueous solution was 1:0.7.

The extruder operating parameters were as follows: the heating temperature in the premixing zone was 60° C., the temperature in the gelatinization zone was 80° C., the temperature in the forming zone was 50° C., and the extruder screw speed was 160 rpm.

The extrudate was cut into segments of approximately 0.5 cm and then dried in an oven at 40° C. for 24 hours. Subsequently, the dried material was pulverized using a continuous cyclone pulverizer equipped with a screen mesh size of 1.0 mm, yielding V-type pregelatinized starch A.

Next, 10 g of the obtained V-type pregelatinized starch A was weighed and placed into a 50 mL centrifuge tube. Then, 35 mL of absolute ethanol was added. The pH of the mixture was adjusted to 11.1 using a 10% sodium hydroxide (NaOH) solution, followed by the addition of 0.7 g of propylene oxide.

The reaction was carried out in a water bath at 75° C. for 4 hours. Upon completion, the reaction was terminated by adjusting the pH of the system to 4.5 using a 10% hydrochloric acid (HCl) solution. The product was then isolated by suction filtration, washed, dried, and pulverized to obtain a hydroxypropyl starch.

### Example 6

Rice starch was selected as the raw material. The solid feed rate of the extruder was set at 600 g/h. An ethanol aqueous solution with an ethanol concentration of 40% by volume was prepared, and the liquid feed rate was adjusted so that the mass ratio of starch to the ethanol aqueous solution was 1:0.9.

The extruder operating parameters were as follows: the heating temperature in the premixing zone was 60° C., the temperature in the gelatinization zone was 75° C., the temperature in the forming zone was 50° C., and the extruder screw speed was 160 rpm.

The extrudate was cut into segments of approximately 0.5 cm and then dried in an oven at 40° C. for 20 hours. Subsequently, the dried material was pulverized using a continuous cyclone pulverizer equipped with a screen mesh size of 1.0 mm, yielding V-type pregelatinized starch A.

Next, 10 g of the obtained V-type pregelatinized starch A was weighed and placed into a 50 mL centrifuge tube. Then, 40 mL of absolute ethanol was added. The pH of the mixture was adjusted to 11.0 using a 10% sodium hydroxide (NaOH) solution, followed by the addition of 0.7 g of propylene oxide.

The reaction was carried out in a water bath at 65° C. for 8 hours. Upon completion, the reaction was terminated by adjusting the pH of the system to 5.0 using a 10% hydrochloric acid (HCl) solution. The product was then isolated by suction filtration, washed, dried, and pulverized to obtain a hydroxypropyl starch.

### Comparison Example 1

This comparison example differs from Example 1 solely in that deionized water was used instead of ethanol during the extrusion step. The specific procedure was as follows:

Tapioca starch was selected. The solid feed rate of the extruder was set at 600 g/h. Deionized water was used, and the liquid feed rate was adjusted so that the mass ratio of starch to deionized water was 1:0.56.

The extruder operating parameters were identical to those in Example 1: the heating temperature in the premixing zone was 60° C., the temperature in the gelatinization zone was 95° C., the temperature in the forming zone was 50° C., and the extruder screw speed was 100 rpm.

The extrudate was cut into segments of approximately 0.5 cm and then dried in an oven at 40° C. for 20 hours. Subsequently, the dried material was pulverized using a continuous cyclone pulverizer equipped with a screen mesh size of 1.0 mm, yielding alcohol-free extruded pregelatinized starch.

Next, 10 g of this alcohol-free extruded pregelatinized starch was weighed and placed into a 50 mL centrifuge tube. Then, 30 mL of an ethanol aqueous solution with a concentration of 85% by volume was added. The pH of the mixture was adjusted to 11.0 using a 10% sodium hydroxide (NaOH) solution, followed by the addition of 0.7 g of propylene oxide.

The reaction was carried out in a water bath at 75° C. for 6 hours. Upon completion, the reaction was terminated by adjusting the pH of the system to 5.0 using a 10% hydrochloric acid (HCl) solution. The product was then isolated by suction filtration, washed, dried, and pulverized to obtain a pregelatinized hydroxypropyl starch.

### Comparison Example 2

This comparison example differs from Example 1 in that native starch was directly subjected to the hydroxypropylation reaction without undergoing the ethanolic extrusion pretreatment. The specific procedure was as follows:

10 g of native tapioca starch was weighed and placed into a 50 mL centrifuge tube. Then, 30 mL of an ethanol aqueous solution with a concentration of 85% by volume was added. The pH of the mixture was adjusted to 11.0 using a 10% sodium hydroxide (NaOH) solution, followed by the addition of 0.7 g of propylene oxide.

The reaction was carried out in a water bath at 75° C. for 6 hours. Upon completion, the reaction was terminated by adjusting the pH of the system to 5.0 using a 10% hydrochloric acid (HCl) solution. The product was then isolated by suction filtration, washed, dried, and pulverized to obtain a hydroxypropyl starch.

### Comparison Example 3

Tapioca starch was selected. The solid feed rate of the extruder was set at 600 g/h. An ethanol aqueous solution with an ethanol concentration of 40% by volume was prepared. The liquid feed rate was adjusted so that the mass ratio of starch to the ethanol aqueous solution was 1:1.5 (in contrast to the 1:0.56 ratio used in Example 1).

The extruder operating parameters were identical to those in Example 1: the heating temperature in the premixing zone was 60° C., the temperature in the gelatinization zone was 95° C., the temperature in the forming zone was 50° C., and the extruder screw speed was 100 rpm.

The extrudate was cut into segments of approximately 0.5 cm and then dried in an oven at 40° C. for 20 hours. Subsequently, the dried material was pulverized using a continuous cyclone pulverizer equipped with a screen mesh size of 1.0 mm, yielding V-type pregelatinized starch A.

The subsequent hydroxypropylation reaction steps were identical to those in Example 1:10 g of the obtained V-type pregelatinized starch A was weighed and placed into a 50 mL centrifuge tube. Then, 30 mL of an ethanol aqueous solution with a concentration of 85% by volume was added. The pH was adjusted to 11.0 using a 10% sodium hydroxide (NaOH) solution, followed by the addition of 0.7 g of propylene oxide. The reaction proceeded in a water bath at 75° C. for 6 hours, was terminated by adjusting the pH to 5.0 with 10% hydrochloric acid (HCl) solution, and the product was isolated via suction filtration, washed, dried, and pulverized to obtain the pregelatinized hydroxypropyl starch.

The degree of substitution and water separation rate of the hydroxypropyl starch samples prepared in Examples 1-6 and Comparison Examples 1-3 were measured. The specific results are presented in Table 1 below:

TABLE 1
Parameters of hydroxypropyl starch prepared
in Examples 1-6 and Comparison Examples 1-3

| | | Water | |
|---|---|---|---|
| | Degree of | Separation | Agglomeration |
| | substitution | Rate | Rate |
| Example 1 | 0.131 | 53.03% | 6.44% |
| Example 2 | 0.157 | 45.16% | 5.17% |
| Example 3 | 0.092 | 59.61% | 8.51% |
| Example 4 | 0.094 | 59.53% | 8.10% |
| Example 5 | 0.120 | 55.47% | 7.79% |
| Example 6 | 0.094 | 62.96% | 9.77% |
| Comparison Example 1 | 0.059 | 69.10% | 17.54% |
| Comparison Example 2 | 0.033 | / | |
| Comparison Example 3 | 0.076 | 66.23% | 11.23% |

As shown in Table 1, the hydroxypropyl starch prepared according to the examples of the disclosure, using only 7% propylene oxide addition, exhibits a degree of substitution greater than 0.09, reaching as high as 0.157, which is significantly higher than that of the hydroxypropyl starch prepared in Comparison Examples 1-2. This demonstrates that the V-type starch obtained after ethanolic extrusion possesses high reactivity and is suitable for the efficient preparation of hydroxypropyl pregelatinized starch. Furthermore, because the hydroxypropyl group itself is bulky, it creates steric hindrance between sugar chains. Simultaneously, the hydroxypropyl group enhances hydrogen bonding between starch molecules and water molecules in an aqueous system, thereby resulting in starch that is more readily dispersed and dissolved.

It will be obvious to those skilled in the art that changes and modifications may be made, and therefore, the aim in the appended claims is to cover all such changes and modifications.

1. A method for preparing a V-type pregelatinized hydroxypropyl starch, comprising:
(1) extruding a mixture of a starch and an ethanol aqueous solution to form an extrudate, drying and pulverizing the extrudate to obtain an extrusion-modified starch A, wherein the ethanol aqueous solution has an ethanol concentration of 30% to 50% by volume, and a mass ratio of the starch to the ethanol aqueous solution is from 1:0.4 to 1:1; and
(2) contacting the extrusion-modified starch A with an ethanol solution, adjusting a pH of a resulting mixture to an alkaline range, contacting the resulting mixture with propylene oxide under reaction conditions to form a reaction mixture, adjusting a pH of the reaction mixture to an acidic range to terminate the reaction, separating a solid product from the reaction mixture by suction filtration, washing the solid product, and drying the solid product, thereby obtaining the V-type pregelatinized hydroxypropyl starch.

2. The method of claim 1, wherein the starch comprises one or more selected from the group consisting of ordinary corn starch, rice starch, potato starch, wheat starch, barley starch, and tapioca starch.

3. The method of claim 1, wherein the extruding in (1) is performed using an extruder; and parameters of the extruder are set to: a heating temperature in a premixing zone of 50° C. to 60° C., a temperature in a gelatinization zone of 70° C. to 100° C., a temperature in a forming zone of 40° C. to 50° C., and an extruder screw speed of 80 to 200 rpm.

4. The method of claim 1, wherein the ethanol solution in (2) has an ethanol concentration of 80% to 100% by volume.

5. The method of claim 1, wherein in (2), a mass ratio of the extrusion-modified starch A to the ethanol solution is from 1:3 to 1:4.

6. The method of claim 1, wherein in (2), the alkaline range is from 10.5 to 12.0.

7. The method of claim 1, wherein in (2), an amount of the propylene oxide added is 5% to 7% by mass of the starch; and the reaction is performed by maintaining a temperature of 60° C. to 80° C. for 4 to 10 hours after adding the propylene oxide.

8. The method of claim 1, wherein in (2), the acidic range is from 4.0 to 6.0.

9. A V-type pregelatinized hydroxypropyl starch, being prepared according to the method of claim 1.

10. (canceled)
